(19) United States
(12) Patent Application Publication
(10) Pub. No.: US 2015/0081555 A1
(43) Pub. Date: Mar. 19, 2015

(54) Method, Apparatus, and System for Processing Transactions

(71) Applicant: Tencent Technology (Shenzhen) Company Limited, Shenzhen (CN)

(72) Inventors: Nan JIANG, Shenzhen (CN); Hongbo SHI, Shenzhen (CN); Jun SHI, Shenzhen (CN); Peng LIU, Shenzhen (CN); Maocai LI, Shenzhen (CN); Chen GONG, Shenzhen (CN)

(73) Assignee: Tencent Technology (Shenzhen) Company Limited

(21) Appl. No.: 14/530,392

(22) Filed: Oct. 31, 2014

Related U.S. Application Data
(63) Continuation of application No. PCT/CN2014/070660, filed on Jan. 15, 2014.

(30) Foreign Application Priority Data
Mar. 18, 2013 (CN) 201310086272.3

(51) Int. Cl. G06Q 20/40; G06Q 20/32; G06Q 20/20

(52) U.S. Cl. CPC G06Q 20/40; G06Q 20/20; G06Q 20/3278
USPC 705/44

(57) ABSTRACT

A method, apparatus, and system for processing transactions are disclosed in the field of Internet communication. The method includes: a first terminal device transmits a user ID of a first party and an account ID of a user account to a computer system; the computer system generates an authorization ID according to the account ID and the user ID, creates a corresponding relationship between the authorization ID and the account information of the user account, and transmits the authorization ID to the first terminal device; a second terminal device acquires the authorization ID from the first terminal device and transmits transaction information of a transaction and the authorization ID to the computer system; the computer system reduces the transaction value from a first value included in the user account of the first party and adds the transaction value to a second value included in the user account of the second party.

### CROSS-REFERENCE TO RELATED APPLICATIONS

This application is a continuation of International Application No. PCT/CN2014/070660, filed on Jan. 15, 2014, which claims priority to Chinese Patent Application No. 201310086272.3, filed on Mar. 18, 2013, which is hereby incorporated herein by reference in its entirety.

### FIELD

The present disclosure relates generally to the field of Internet communication and, more particularly, to a method, apparatus and system for processing transactions.

### BACKGROUND

In everyday life, people often need to purchase merchandises and fully pay the amounts due. For example, people often make their picks and proceed to the cashier counter to make payment; the cashier inputs the merchandises to the cashing machine and the cashing machine sums up the amount payable; and the amount may then be paid using payment card.

When making card payment for merchandises purchased, the customer's payment card needs to be slid through the point-of-sale (POS) terminal and the payment card password needs to be inputted. When the customer slides a payment card through and inputting the payment card password to a POS terminal in a supermarket or emporium, the card number and password may be easily seen and stolen by others. If the card number and the password are stolen, criminals may obtain the personal information and account information of the payment card through enquiry and this poses a considerable threat to the security of personal information and account information.

### SUMMARY

To improve the security of personal information and account information, the present disclosure provides a method, apparatus and system for processing transactions. The technical schemes of the present disclosure are as follows:

In one aspect, a method for processing transactions is disclosed. In the method, including: a first terminal device transmits a user ID of a first party and an account ID of a user account thereof to a computer system; the computer system generates an authorization ID according to the account ID and the user ID and creates a corresponding relationship between the authorization ID and the account information of the user account, the account information including IDs of the user account and account management system of the first party, and transmits the authorization ID to the first terminal device; a second terminal device acquires the authorization ID from the first terminal device and transmits transaction information of a transaction and the authorization ID to the computer system, the transaction information including at least ID of the second party and transaction value of the transaction; the computer system reduces the transaction value from a first value included in the user account of the first party and adds the transaction value to a second value included in the user account of the second party according to the stored corresponding relationship between the authorization ID and the account information, the authorization ID and the transaction information.

A method for processing transactions, including: receive a user ID of a first party and an account ID of a user account thereof transmitted from the first terminal device, generate an authorization ID according to the account ID and the user ID and create a corresponding relationship between the authorization ID and the account information of the user account, the account information including IDs of the user account and account management system of the first party, and transmit the authorization ID to the first terminal device; receive transaction information of a transaction and the authorization ID transmitted from a second terminal device, the authorization ID being acquired by the second terminal device from the first terminal device, the transaction information including at least ID of the second party and transaction value of the transaction; reduce the transaction value from a first value included in the user account of the first party and add the transaction value to a second value included in the user account of the second party according to the stored corresponding relationship between the authorization ID and the account information, the authorization ID and the transaction information.

A system for processing transactions, including: a first terminal device, a second terminal device and a computer system; wherein: the first terminal device is configured to transmit a user ID of a first party and an account ID of a user account thereof to the computer system; the computer system is configured to generate an authorization ID according to the account ID and the user ID and to create a corresponding relationship between the authorization ID and the account information of the user account, the account information including IDs of the user account and account management system of the first party, and to transmit the authorization ID to the first terminal device; the second terminal device is configured to acquire the authorization ID from the first terminal device and to transmit transaction information of a transaction and the authorization ID to the computer system, the transaction information including at least ID of the second party and transaction value of the transaction; computer system is also configured to reduce the transaction value from a first value included in the user account of the first party and to add the transaction value to a second value included in the user account of the second party according to the stored corresponding relationship between the authorization ID and the account information, the authorization ID and the transaction information.

An apparatus for processing transactions, including: an acquisition module configured to receive a user ID of a first party and an account ID of a user account thereof transmitted from the first terminal device, to generate an authorization ID according to the account ID and the user ID and to create a corresponding relationship between the authorization ID and the account information of the user account, the account information including IDs of the user account and account management system of the first party, and to transmit the authorization ID to the first terminal device; a reception module configured to receive transaction information of a transaction and the authorization ID transmitted from a second terminal device, the authorization ID being acquired by the second terminal device from the first terminal device, the transaction information including at least ID of the second party and transaction value of the transaction; a reduction module configured to reduce the transaction value from a first value included in the user account of the first party and add the transaction value to a second value included in the user account of the second party according to the stored corresponding relationship between the authorization ID and the account information, the authorization ID and the transaction information.

### BRIEF DESCRIPTION OF THE DRAWINGS

FIG. 1 is a process flow diagram of a method for processing transactions according to an example embodiment of the present disclosure.

FIG. 2 is a process flow diagram of a method for processing transactions according to an example embodiment of the present disclosure.

FIG. 3 is a structural block diagram of a system for processing transactions according to an example embodiment of the present disclosure.

FIG. 4 is a process flow diagram of a method for processing transactions according to an example embodiment of the present disclosure.

FIG. 5 is a process flow diagram of a method for processing transactions according to an example embodiment of the present disclosure.

FIG. 6 is a schematic block diagram of a system for processing transactions according to an example embodiment of the present disclosure.

FIG. 7 is a schematic block diagram of an apparatus for processing transactions according to an example embodiment of the present disclosure.

### DETAILED DESCRIPTION OF THE DRAWINGS

For a better understanding of the aim, technical schemes and advantages of the present invention, example embodiments are described in detail in connection with the accompanying drawings as follows.

In the example embodiments of the disclosure, during the process of processing a transaction, the account information of the user account of the first party is located in the payment computer system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the second terminal device acquires the authorization ID directly from the first terminal device, thereby ensuring that the authorization ID is not exposed directly and stolen by others and improving the security of personal information and account information.

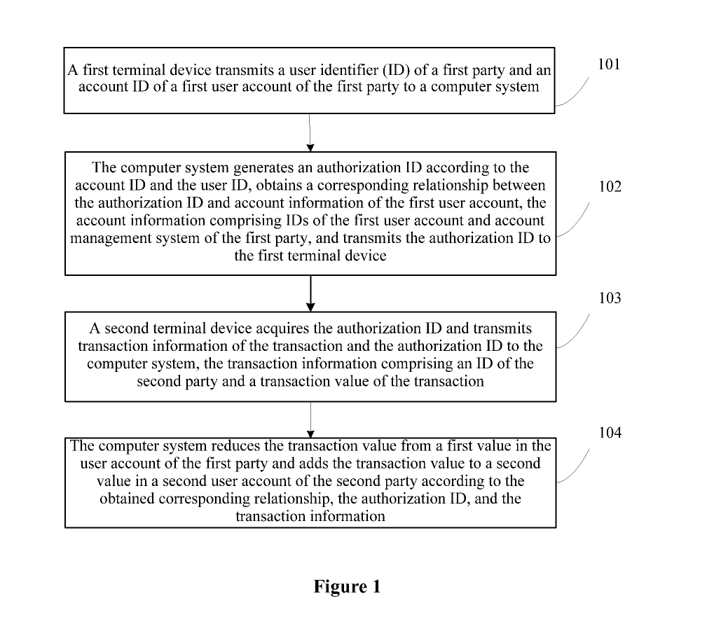

Referring to FIG. 1, this embodiment of the disclosure provides a method for processing transactions, and the method includes:

Act 101: a first terminal device transmits a user ID of a first party and an account ID of a user account thereof to a payment system;

Act 102: the payment system generates an authorization ID according to the account ID and the user ID and creates a corresponding relationship between the authorization ID and the account information of the user account, the account information including IDs of the user account and account management system of the first party, and transmits the authorization ID to the first terminal device;

Act 103: a second terminal device acquires the authorization ID from the first terminal device and transmits transaction information of a transaction and the authorization ID to the payment system, the transaction information including at least ID of the second party and transaction value of the transaction;

Act 104: the payment system reduces the transaction value from a first value included in the user account of the first party and adds the transaction value to a second value included in the user account of the second party according to the stored corresponding relationship between the authorization ID and the account information, the authorization ID and the transaction information.

The first terminal device may be a mobile terminal installed with a processing system. For example, the first terminal device may be a mobile phone, a tablet computer, a personal digital assistant (PDA), or any electronic device having a hardware processor. The second terminal device may be a point-of-sale (POS) machine. The payment system may be a computer system including at least one computer server. The payment system may also include a database that stores information related to the first and second parties.

In this embodiment of the disclosure, a first terminal device transmits a user ID of a first party and an account ID of a user account thereof to a payment system; the payment system generates an authorization ID according to the account ID and the user ID and creates a corresponding relationship between the authorization ID and the account information of the user account, and transmits the authorization ID to the first terminal device; a second terminal device acquires the authorization ID from the first terminal device and transmits transaction information of a transaction and the authorization ID to the payment system; the payment system reduces the transaction value from a first value included in the user account of the first party and adds the transaction value to a second value included in the user account of the second party according to the stored corresponding relationship between the authorization ID and the account information, the authorization ID and the transaction information. In the entire processing process, the account information of the user account of the first party is located in the payment system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the second terminal device acquires the authorization ID directly from the first terminal device, thereby ensuring that the authorization ID is not exposed directly and stolen by others and improving the security of personal information and account information.

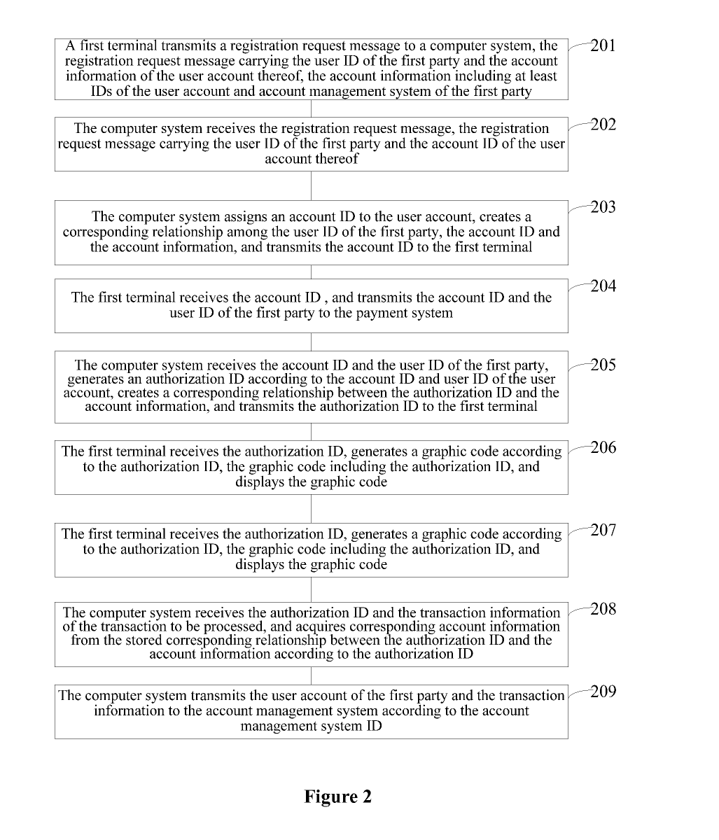

Referring to FIG. 2, this embodiment of the disclosure provides a method for processing transactions, and the method includes:

Act 201: a first terminal device transmits a registration request message to a payment computer system, the registration request message carrying the user ID of the first party and the account information of the user account thereof, the account information including at least IDs of the user account and account management system of the first party;

When the first party needs to register a certain user account in the payment computer system, the first party may input the account information of the user account and the user ID of the first party; the first terminal device receives the account information of the user account and the user ID of the first party and transmits the registration request messaging carrying the account information of the user account and the user ID of the first party to the payment system.

The first party may also input a user password to the first terminal device; further, the first terminal device receives the user password inputted by the first party; accordingly, the registration request message may also carry the user password of the first party.

The first party may register the user ID and user password thereof in the payment system in advance and the payment system stores the user ID and user password registered by the first party.

In one embodiment of the disclosure, the first party has the registration request message transmitted to the payment system by the first terminal device to request the payment system to bind the user ID of the first party, and the account ID and account information of the user account thereof.

In one embodiment of the disclosure, a third party may also have a registration request message transmitted to the payment system by other terminal, e.g. having a registration request message transmitted to the payment system by a PC terminal.

In one embodiment of the disclosure, the first party may be a user; the user account may be a bank account of a stored-value card, a credit card, a bank deposit card or a bank passbook, or a virtual account for storing virtual currency; the account management system may be a stored-value card issuance system or a bank; the user ID of the first party may be a user identity (ID) for identifying the first party; the account ID of the user account may be the ID of the user account for identifying the user account; the first terminal device may be a mobile terminal, e.g. the first terminal device may be a mobile terminal installed with processing system, such as a mobile phone, a tablet, or any computing device having at least one processor.

Act 202: the payment computer system receives the registration request message, the registration request message carrying the user ID of the first party and the account ID of the user account thereof;

If the first party inputs a user password to the first terminal device, the registration request message will also carry the user password inputted by the first party.

Act 203: The payment computer system assigns an account ID to the user account, creates a corresponding relationship among the user ID of the first party, the account ID of the user account and the account information of the user account, and transmits the account ID of the user account to the first terminal device;

For example, the payment computer system assigns an account ID to the user account, the account ID uniquely identifying the user account, stores the user ID of the first party, the account ID of the user account and the account information of the user account in the corresponding relationship among the user ID, the account ID and the account information.

Further, if the registration request message also carries the user password of the first party, then the third party verifies the identity of the first party according to the user password of the first party before performing this act; if the verification is passed, the payment system performs this act, and if the verification is not passed, this act is not performed; the verification process may be as follows:

The payment computer system searches for the stored corresponding relationship between the user ID and the user password; if any record including the user ID and the user password of the first party is found, verification of the identity of the first party is passed; if no record including the user ID and the user password of the first party is found, then verification of the identity of the first party is not passed.

The first terminal device receives the account ID of the user account transmitted from the payment system and displays the account ID of the user account to the first party.

In one embodiment of the disclosure, the first party may register his/her multiple user accounts in the payment system according to the aforesaid acts 201 through 203.

In one embodiment of the disclosure, when the first party needs to process a transaction, the first terminal device may process the transaction according to the following act; the transaction may be a merchandise or service.

Act 204: the first terminal device receives the account ID of the user account, and transmits the account ID of the user account and the user ID of the first party to the payment system;

wherein the first party may directly input the account ID of the user account to the first terminal device; or the first terminal device may display the account ID of the user account to the first party, the first party selects the account ID of a certain user account, the first terminal device receives the account ID of the user account selected by the user.

The first terminal device may save the user ID of the first party in advance, and the first terminal device may read the stored user account of the first party prior to transmitting the user ID of the first party; or the first terminal device may directly receive the user account inputted by the first party.

Further, the first terminal device may also receive the user password inputted by the first party, and accordingly, the first terminal device transmits the account ID of the user account, the user account and user password of the first party together to the payment system.

Act 205: the payment computer system receives the account ID of the user account and the user ID of the first party, generates an authorization ID according to the account ID and user ID of the user account, creates a corresponding relationship between the authorization ID and the account information of the user account, and transmits the authorization ID to the first terminal device;

For example, the payment system receives the account ID of the user account and the user ID of the first party; acquires the account information of the user account from the stored corresponding relationship among the user ID, the account ID and the account information according to the account ID of the user account and the user ID of the first party; generates an authorization ID according to the account information of the user account and the current time, the authorization ID being configured to identify the account information of the user account; stores the authorization ID and the account information of the user account in a corresponding relationship between the authorization ID and the account information; and transmits the authorization ID to the first terminal device.

The operation of payment system generating an authorization ID according to the account information of the user account and the current time may be as follows:

Use a hashing algorithm to add scrambling codes like the current time to the account information of the user account to obtain a hash value, and determine the hash value as an authorization ID.

Further, the payment system may also receive the user password of the first party and verify the identity of the first party according to the user ID and user password of the first party before generating an authorization ID and creating a corresponding relationship between the authorization ID and the account information of the user account; if the verification is passed, the payment system will perform the operations of generating an authorization ID and creating a corresponding relationship between the authorization ID and the account information of the user account, and if the verification is not passed, the payment system will not perform he operations of generating an authorization ID and creating a corresponding relationship between the authorization ID and the account information of the user account.

Act 206: the first terminal device receives the authorization ID, generates a graphic code according to the authorization ID, the graphic code including the authorization ID, and displays the graphic code;

wherein the first terminal device may convert the authorization ID to a graphic code according to the authorization ID through standard graphic code conversion algorithm, wherein the graphic code may be a two-dimensional code or a two-dimensional barcode.

After display of the graphic code by the first terminal device, a second terminal device required to process an transaction may scan the graphic code displayed by the first terminal device; wherein the second terminal device includes a graphic code verifier and the second terminal device may scan the graphic code displayed by the first terminal device by means of its own graphic code verifier.

The second terminal device may be connected to the cashier counter corresponding to a second party and when the first party needs to process a transaction, the cashier counter corresponding to the second party may be used to scan the graphic code of the transaction; the cashier counter corresponding to the second party scans the graphic code of the transaction and forms a processing order of the transaction, the processing order including at least ID of the second party and transaction value of the transaction; and transmits the processing order of the transaction to the second terminal device.

The second party may be a merchant, the transaction value of the transaction may be the monetary amount required to settle the transaction of the transaction, and the second terminal device may be a point-of-sale machine.

Further, the processing order of the transaction may also include an order number and/or descriptive information of the transaction, and the descriptive information of the transaction may be the name and/or price or other information of the transaction.

Act 207: a second terminal device scans the graphic code displayed by the first terminal device, generates an authorization ID from the scanned graphic code, and transmits the authorization ID and the transaction information of the transaction to the payment system, the transaction information including at least ID of a second party and transaction value of the transaction;

For example, the second terminal device scans the graphic code displayed by the first terminal device, generates an authorization ID from the scanned graphic code, receives a processing order of the transaction from the cashier counter corresponding to the second party, acquires transaction information of the transaction according to the processing order of the transaction, and transmits the authorization ID and the transaction information of the transaction to the payment system.

Act 208: the payment computer system receives the authorization ID and the transaction information of the transaction, and acquires corresponding account information from the stored corresponding relationship between the authorization ID and the account information according to the authorization ID, the account information including IDs of the user account and account management system of the first party;

Act 209: the payment computer system transmits the user account of the first party and the transaction information to the account management system according to the account management system ID, causing the account management system to reduce the transaction value from a first value included in the user account of the first party and to add the transaction value to a second value included in the user account of the second party according to the user account of the first party and the transaction information.

The account management system receives the user account of the first party and the transaction information, the transaction information including at least ID of the second party and the transaction value of the transaction; acquires the user account of the second party according to the ID of the second party; reduces the transaction value from a first value included in the user account of the first party, and adds the reduced transaction value to a second value included in the user account of the second party according to the transaction value of the transaction. The user account of the second party may be a merchant account.

In one embodiment of the disclosure: the first terminal device may first transmit the authorization ID and the transaction information of the transaction to the bill reception system corresponding to the second party; the bill reception system corresponding to the second party receives the authorization ID and the transaction information of the transaction, and transmits the authorization ID to the payment system.

The payment computer system receives the authorization ID, acquires corresponding account information from the stored corresponding relationship between the authorization ID and the account information according to the authorization ID, and transmits the account information to a bill reception system corresponding to the second party, the account information including the user account of the first party and the account management system ID; the bill reception system corresponding to the second party receives the account information, and transmits the user account of the first party and the transaction information of the transaction to the corresponding account management system according to the account management system ID.

The account management system receives the user account of the first party and the transaction information of the transaction, the transaction information including at least the ID of the second party and the transaction value of the transaction; acquires the user account corresponding to the second party according to the ID of the second party; reduces the transaction value from a first value included in the user account of the first party, and adds the reduced transaction value to a second value included in the user account of the second party according to the transaction value of the transaction.

After performing the said act the payment system may delete the corresponding relationship involving the authorization ID and the account information of the user account of the first party from the stored corresponding relationship between the authorization ID and the account information; or, after performing the said act, the payment system may set an invalid ID for the corresponding relationship involving the authorization ID and the account information of the user account of the first party in the stored corresponding relationship between the authorization ID and the account information.

When the payment system receives the authorization ID again, the payment system acquires the corresponding relationship involving the authorization ID and the invalid ID of the corresponding relationship according to the authorization ID, determines the authorization ID as invalid according to the invalid ID, and stops performing processing operation.

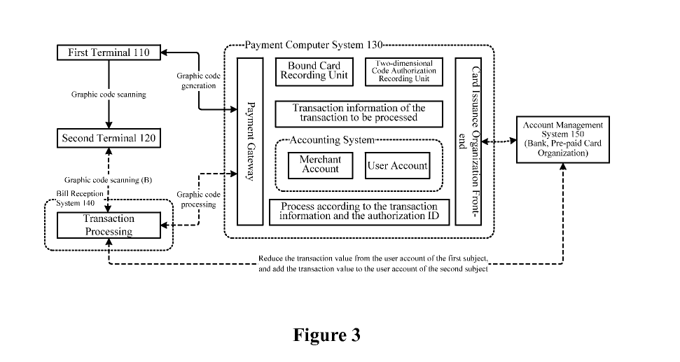

Referring to FIG. 3, an example system structure useable in this embodiment of the disclosure is illustrated. The example system includes a first terminal 110, a second terminal 120, a payment computer system 130, a bill reception system 140, and an account management system 150. The first party may be a user using the first terminal 110. The second party may be a merchant using the second terminal 120. The user account corresponding to the second party may be a merchant account. The second terminal device 120 may be a point-of-sale terminal. The bound card recording unit of the payment system binds the user ID, account ID and account information registered by the first party in advance, i.e. establishes a corresponding relationship among the user ID, account ID and account information registered by the first party.

When the first party processes the transaction, the two-dimensional code authorization recording unit of the payment computer system 130 acquires the corresponding account information according to the user ID and account ID of the first party, generates an authorization ID, and creates a corresponding relationship between the authorization ID and the account information. The payment system 130 transmits the authorization ID to the first terminal device through the payment gateway.

The first terminal device 110 generates and displays a two-dimensional code according to the authorization ID. The second terminal device 120 scans the two-dimensional code, acquires the authorization ID, and transmits the authorization ID and the transaction information of the transaction to the payment gateway of the payment system 130. The accounting system of the payment system 130 acquires the corresponding account information of the user account of the first party from the corresponding relationship between the authorization ID and the account information stored in the two-dimensional code authorization record according to the authorization ID, reduces the transaction value from the user account of the first party in the account management system, and adds the transaction value to the merchant account. Alternatively, the second terminal device 120 transmits the authorization ID and the transaction information of the transaction to the bill reception system 140. The bill reception system 140 transmits the authorization ID to the payment system 130. The payment computer system 130 receives the authorization ID, acquires corresponding account information of the user account of the first party from the corresponding relationship between the authorization ID and the account information stored in the two-dimensional code authorization record, and transmits the account information of the user account to the bill reception system 140. The bill reception system 140 reduces the transaction value from the user account of the first party in the account management system and adds the transaction value to the merchant account according to the account information of the user account of the first party and the transaction information.

In this embodiment of the disclosure, a first terminal device transmits a user ID of a first party and an account ID of a user account thereof to a payment system; the payment system generates an authorization ID according to the account ID and the user ID and creates a corresponding relationship between the authorization ID and the account information of the user account; the first terminal device receives the authorization ID transmitted from the payment system and generates and displays a graphic code according to the authorization ID. In the entire processing process, the account information of the user account of the first party is located in the payment system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the first terminal device generates a graphic code containing the identification ID for scanning by the second terminal device thus disenabling others to acquire the authorization ID by viewing the graphic code, thereby ensuring that the authorization ID is not exposed directly and stolen by others and improving the security of personal information and account information.

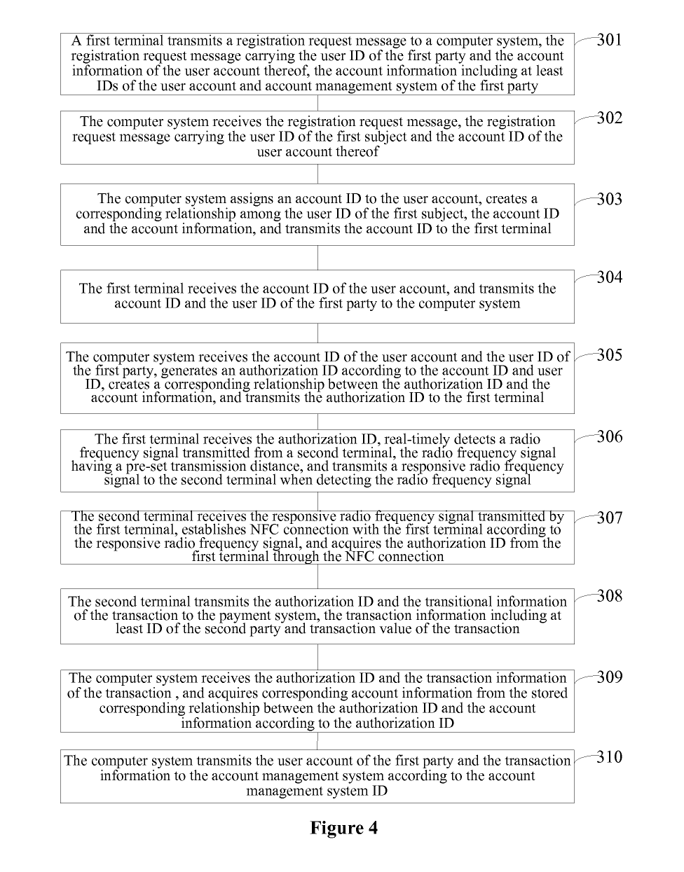

This embodiment of the disclosure provides a method for processing transactions, wherein after a first terminal device acquires an authorization ID from a payment system, an object scanning terminal may use short-range wireless NFC (near field communication) technique to establish NFC connection with the first terminal device, acquire the authorization ID from the first terminal device, and process the transaction according to the authorization ID. Referring to FIG. 4, the method includes:

Act 301: a first terminal device transmits a registration request message to a payment computer system, the registration request message carrying the user ID of the first party and the account information of the user account thereof, the account information including at least IDs of the user account and account management system of the first party;

wherein when the first party needs to register a certain user account in the payment system, the first party may input the account information of the user account and the user ID of the first party; the first terminal device receives the account information of the user account and the user ID of the first party and transmits the registration request messaging carrying the account information of the user account and the user ID of the first party to the payment system.

The first party may also input a user password to the first terminal device; further, the first terminal device receives the user password inputted by the first party; accordingly, the registration request message may also carry the user password of the first party.

The first party may register the user ID and user password thereof in the payment system in advance and the payment system stores the user ID and user password registered by the first party.

In one embodiment of the disclosure, the first party has the registration request message transmitted to the payment computer system by the first terminal device to request the payment system to bind the user ID of the first party, and the account ID and account information of the user account thereof.

In one embodiment of the disclosure, a third party may also have a registration request message transmitted to the payment computer system by other terminal, e.g. having a registration request message transmitted to the payment computer system by a PC terminal.

In one embodiment of the disclosure, the first party may be a user; the user account may be a bank account of a stored-value card, a credit card, a bank deposit card or a bank passbook, or a virtual account for storing virtual currency; the account management system may be a stored-value card issuance system or a bank.

Act 302: the payment computer system receives the registration request message, the registration request message carrying the user ID of the first party and the account ID of the user account thereof;

wherein if the first party inputs a user password to the first terminal device, the registration request message will also carry the user password inputted by the first party.

Act 303: the payment computer system assigns an account ID to the user account, creates a corresponding relationship among the user ID of the first party, the account ID of the user account and the account information of the user account, and transmits the account ID of the user account to the first terminal device;

For example, the payment system assigns an account ID to the user account, the account ID uniquely identifying the user account, stores the user ID of the first party, the account ID of the user account and the account information of the user account in the corresponding relationship among the user ID, the account ID and the account information.

Further, if the registration request message also carries the user password of the first party, then the third party verifies the identity of the first party according to the user password of the first party before performing this act; if the verification is passed, the payment system performs this act, and if the verification is not passed, this act is not performed; the verification process may be as follows:

The payment computer system searches for the stored corresponding relationship between the user ID and the user password; if any record including the user ID and the user password of the first party is found, verification of the identity of the first party is passed; if no record including the user ID and the user password of the first party is found, then verification of the identity of the first party is not passed.

The first terminal device receives the account ID of the user account transmitted from the payment system and displays the account ID of the user account to the first party.

In one embodiment of the disclosure, the first party may register his/her multiple user accounts in the payment system according to the aforesaid acts 301 through 303.

In one embodiment of the disclosure, when the first party needs to process a transaction, the first terminal device may process the transaction according to the following act; the transaction may be a merchandise or service.

Act 304: the first terminal device receives the account ID of the user account, and transmits the account ID of the user account and the user ID of the first party to the payment system;

wherein the first party may directly input the account ID of the user account to the first terminal device; or the first terminal device may display the account ID of the user account to the first party, the first party selects the account ID of a certain user account, the first terminal device receives the account ID of the user account selected by the user.

The first terminal device may save the user ID of the first party in advance, and the first terminal device may read the stored user account of the first party prior to transmitting the user ID of the first party; or the first terminal device may directly receive the user account inputted by the first party.

Further, the first terminal device may also receive the user password inputted by the first party, and accordingly, the first terminal device transmits the account ID of the user account, the user account and user password of the first party together to the payment system.

Act 305: the payment computer system receives the account ID of the user account and the user ID of the first party, generates an authorization ID according to the account ID and user ID of the user account, creates a corresponding relationship between the authorization ID and the account information of the user account, and transmits the authorization ID to the first terminal device;

For example, the payment computer system receives the account ID of the user account and the user ID of the first party; acquires the account information of the user account from the stored corresponding relationship among the user ID, the account ID and the account information according to the account ID of the user account and the user ID of the first party; generates an authorization ID according to the account information of the user account and the current time, the authorization ID being configured to identify the account information of the user account; stores the authorization ID and the account information of the user account in a corresponding relationship between the authorization ID and the account information; and transmits the authorization ID to the first terminal device.

The operation of payment computer system generating an authorization ID according to the account information of the user account and the current time may be as follows:

Use a hashing algorithm to add scrambling codes like the current time to the account information of the user account to obtain a hash value, and determine the hash value as an authorization ID.

Further, the payment computer system may also receive the user password of the first party and verify the identity of the first party according to the user ID and user password of the first party before generating an authorization ID and creating a corresponding relationship between the authorization ID and the account information of the user account; if the verification is passed, the payment system will perform the operations of generating an authorization ID and creating a corresponding relationship between the authorization ID and the account information of the user account, and if the verification is not passed, the payment system will not perform he operations of generating an authorization ID and creating a corresponding relationship between the authorization ID and the account information of the user account.

Act 306: the first terminal device receives the authorization ID, real-timely detects a radio frequency signal transmitted from a second terminal device, the radio frequency signal having a pre-set transmission distance, and transmits a responsive radio frequency signal to the second terminal device when detecting the radio frequency signal;

wherein the second terminal device real-timely transmits a radio frequency signal, the radio frequency signal having a pre-set transmission distance; wherein the pre-set transmission distance is smaller than or equal to 10 cm.

The first party may move the first terminal device to the front of the second terminal device and cause the distance between the second terminal device and the first terminal device to be smaller than or equal to the pre-set transmission distance.

When the first terminal device is moved to the front of the second terminal device and the distance between the second terminal device and the first terminal device to be smaller than or equal to the pre-set transmission distance, the first terminal device is able to detect the radio frequency signal real-timely transmitted by the second terminal device.

Act 307: the second terminal device receives the responsive radio frequency signal transmitted by the first terminal device, establishes NFC connection with the first terminal device according to the responsive radio frequency signal, and acquires the authorization ID from the first terminal device through the NFC connection;

For example, the second terminal device receives the responsive radio frequency signal transmitted by the first terminal device and establishes NFC connection with the first terminal device by using NFC technique according to the responsive radio frequency signal, the first terminal device transmits the authorization ID through the NFC connection, and the second terminal device receives the authorization ID through the NFC connection.

The first terminal device uses an encryption key to encrypt the authorization ID and transmits the encrypted authorization ID to the second terminal device through the NFC connection, and the second terminal device receives the encrypted authorization ID and uses a decryption key to decrypt the encrypted authorization ID.

The first terminal device may acquire the encryption key from the payment system, and the second terminal device may acquire the decryption key from the payment system.

The second terminal device may be connected to the cashier counter corresponding to a second party and when the first party needs to process a transaction, the cashier counter corresponding to the second party may be used to scan the graphic code of the transaction; the cashier counter corresponding to the second party scans the graphic code of the transaction and forms a processing order of the transaction, the processing order including at least ID of the second party and transaction value of the transaction; and transmits the processing order of the transaction to the second terminal device.

The second party may be a merchant, the transaction value of the transaction may be the monetary amount required to settle the transaction of the transaction, and the second terminal device may be a point-of-sale machine.

Further, the processing order of the transaction may also include an order number and/or descriptive information of the transaction, and the descriptive information of the transaction may be the name and/or price or other information of the transaction.

Act 308: the second terminal device second terminal device transmits the authorization ID and the transaction information of the transaction to the payment system, the transaction information including at least ID of the second party and transaction value of the transaction;

For example, the second terminal device receives a processing order of the transaction transmitted from the cashier counter corresponding to the second party, acquires transaction information of the transaction according to the processing order of the transaction, and transmits the authorization ID and the transaction information of the transaction to the payment system.

Act 309: the payment system receives the authorization ID and the transaction information of the transaction, and acquires corresponding account information from the stored corresponding relationship between the authorization ID and the account information according to the authorization ID, the account information including IDs of the user account and account management system of the first party;

Act 310: the payment computer system transmits the user account of the first party and the transaction information to the account management system according to the account management system ID, causing the account management system to reduce the transaction value from a first value included in the user account of the first party and to add the transaction value to a second value included in the user account of the second party according to the user account of the first party and the transaction information.

The account management system receives the user account of the first party and the transaction information, the transaction information including at least ID of the second party and the transaction value of the transaction; acquires the user account of the second party according to the ID of the second party; reduces the transaction value from a first value included in the user account of the first party, and adds the reduced transaction value to a second value included in the user account of the second party according to the transaction value of the transaction.

In one example embodiment of the disclosure: the first terminal device may first transmit the authorization ID and the transaction information of the transaction to the bill reception system corresponding to the second party; the bill reception system corresponding to the second party receives the authorization ID and the transaction information of the transaction, and transmits the authorization ID to the payment system.

The payment system receives the authorization ID, acquires corresponding account information from the stored corresponding relationship between the authorization ID and the account information according to the authorization ID, and transmits the account information to a bill reception system corresponding to the second party, the account information including the user account of the first party and the account management system ID; the bill reception system corresponding to the second party receives the account information, and transmits the user account of the first party and the transaction information of the transaction to the corresponding account management system according to the account management system ID.

The account management system receives the user account of the first party and the transaction information of the transaction, the transaction information including at least the ID of the second party and the transaction value of the transaction; acquires the user account corresponding to the second party according to the ID of the second party; reduces the transaction value from a first value included in the user account of the first party, and adds the reduced transaction value to a second value included in the user account of the second party according to the transaction value of the transaction.

After performing the said act the payment system may delete the corresponding relationship involving the authorization ID and the account information of the user account of the first party from the stored corresponding relationship between the authorization ID and the account information; or, after performing the said act, the payment system may set an invalid ID for the corresponding relationship involving the authorization ID and the account information of the user account of the first party in the stored corresponding relationship between the authorization ID and the account information.

When the payment computer system receives the authorization ID again, the payment system acquires the corresponding relationship involving the authorization ID and the invalid ID of the corresponding relationship according to the authorization ID, determines the authorization ID as invalid according to the invalid ID, and stops performing processing operation.

In this embodiment of the disclosure, a first terminal device transmits a user ID of a first party and an account ID of a user account thereof to a payment system; the payment system generates an authorization ID according to the account ID and the user ID, creates a corresponding relationship between the authorization ID and the account information of the user account, and transmits the authorization ID to the first terminal device; a second terminal device acquires the authorization ID from the first terminal device through NFC connection with the first terminal device and transmits the transaction information of a transaction and the authorization ID to the payment system; the payment system reduces the transaction value from a first value included in the user account of the first party and adds the transaction value to a second value included in the user account of the second party according to the stored corresponding relationship between the authorization ID and the account information, the authorization ID and the transaction information. In the entire processing process, the account information of the user account of the first party is located in the payment system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the second terminal device acquires the authorization ID from the first terminal device through NFC connection and the distance of the NFC connection between the first terminal device and the second terminal device is relatively short and within the range of 10 cm, thereby ensuring that the authorization ID is not exposed directly and stolen by others and improving the security of personal information and account information.

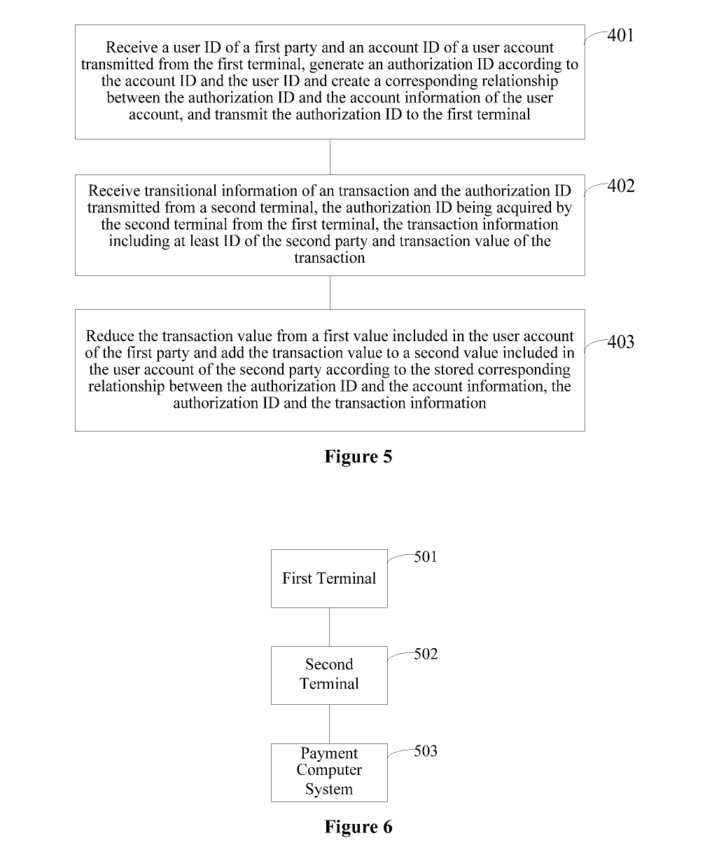

Referring to FIG. 5, this embodiment of the disclosure provides a method for processing transactions, and the method includes:

Act 401: receive a user ID of a first party and an account ID of a user account thereof transmitted from the first terminal device, generate an authorization ID according to the account ID and the user ID and create a corresponding relationship between the authorization ID and the account information of the user account, the account information including IDs of the user account and account management system of the first party, and transmit the authorization ID to the first terminal device;

Act 402: receive transaction information of a transaction and the authorization ID transmitted from a second terminal device, the authorization ID being acquired by the second terminal device from the first terminal device, the transaction information including at least ID of the second party and transaction value of the transaction;

Act 403: reduce the transaction value from a first value included in the user account of the first party and add the transaction value to a second value included in the user account of the second party according to the stored corresponding relationship between the authorization ID and the account information, the authorization ID and the transaction information.

In this embodiment of the disclosure, the method includes: receive a user ID of a first party and an account ID of a user account thereof transmitted from the first terminal device, generate an authorization ID according to the account ID and the user ID and create a corresponding relationship between the authorization ID and the account information of the user account, and transmit the authorization ID to the first terminal device; receive transaction information of a transaction and the authorization ID transmitted from a second terminal device, the authorization ID being acquired by the second terminal device from the first terminal device; reduce the transaction value from a first value included in the user account of the first party and add the transaction value to a second value included in the user account of the second party according to the stored corresponding relationship between the authorization ID and the account information, the authorization ID and the transaction information. In the entire processing process, the account information of the user account of the first party is located in the payment system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the second terminal device acquires the authorization ID directly from the first terminal device, thereby ensuring that the authorization ID is not exposed directly and stolen by others and improving the security of personal information and account information.

Referring to FIG. 6, this embodiment of the disclosure provides a system for processing transactions, and the system includes: a first terminal device 501, a second terminal device 502 and a payment system 503; wherein:

the first terminal device 501 is configured to transmit a user ID of a first party and an account ID of a user account thereof to the payment system;

the payment computer system 503 is configured to generate an authorization ID according to the account ID and the user ID and to create a corresponding relationship between the authorization ID and the account information of the user account, the account information including IDs of the user account and account management system of the first party, and to transmit the authorization ID to the first terminal device 501;

the second terminal device 502 is configured to acquire the authorization ID from the first terminal device 501 and to transmit transaction information of a transaction and the authorization ID to the payment computer system, the transaction information including at least ID of the second party and transaction value of the transaction;

the payment computer system 503 is also configured to reduce the transaction value from a first value included in the user account of the first party and to add the transaction value to a second value included in the user account of the second party according to the stored corresponding relationship between the authorization ID and the account information, the authorization ID and the transaction information.

Further, the first terminal device 501 is also configured to generate and display a graphic code according to the authorization ID, the graphic code including the authorization ID;

accordingly, the second terminal device 502 is configured to scan the graphic code displayed by the first terminal device and to acquire the authorization ID from the graphic code.

The second terminal device 502 is also configured to real-timely transmit a radio frequency signal, of the radio frequency signal having a pre-set transmission distance;

The first terminal device 501 is configured to detect the radio frequency signal and to transmit a responsive radio frequency signal to the second terminal device, wherein the distance between the second terminal device and the first terminal device is smaller than or equal to the pre-set transmission distance; and

Further, the second terminal device 502 is also configured to receive the responsive radio frequency signal, to establish short-range wireless NFC connection with the first terminal device according to the responsive radio frequency signal, and to acquire the authorization ID from the first terminal device through the NFC connection.

Further, the first terminal device 501 is also configured to transmit a registration request message to the payment system, the registration request message carrying the user ID of the first party and the account information of the user account thereof;

the payment computer system 503 is also configured to assign an account ID to the user account, and to create a corresponding relationship among the user ID, the account ID and the account information.

In this embodiment of the disclosure, a first terminal device transmits a user ID of a first party and an account ID of a user account thereof to a payment system; the payment system generates an authorization ID according to the account ID and the user ID and creates a corresponding relationship between the authorization ID and the account information of the user account, and transmits the authorization ID to the first terminal device; a second terminal device acquires the authorization ID from the first terminal device and transmits transaction information of a transaction and the authorization ID to the payment system; the payment system reduces the transaction value from a first value included in the user account of the first party and adds the transaction value to a second value included in the user account of the second party according to the stored corresponding relationship between the authorization ID and the account information, the authorization ID and the transaction information. In the entire processing process, the account information of the user account of the first party is located in the payment system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the second terminal device acquires the authorization ID directly from the first terminal device, thereby ensuring that the authorization ID is not exposed directly and stolen by others and improving the security of personal information and account information.

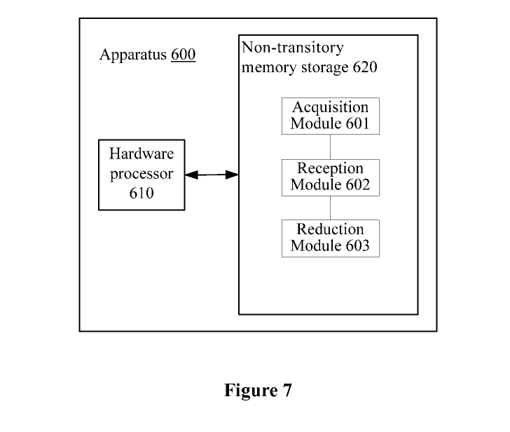

FIG. 7 illustrates an apparatus 600 for processing transactions, and the apparatus 600 includes a hardware processor 610 and a non-transitory storage medium 620 accessible to the hardware processor 610. The non-transitory storage medium 620 is configured to store the following modules implemented by the hardware processor 610: an acquisition module 601, a reception module 602, and a reduction module 603.

The acquisition module 601 is configured to receive a user ID of a first party and an account ID of a user account thereof transmitted from the first terminal device, to generate an authorization ID according to the account ID and the user ID and to create a corresponding relationship between the authorization ID and the account information of the user account, the account information including IDs of the user account and account management system of the first party, and to transmit the authorization ID to the first terminal device.

The reception module 602 is configured to receive transaction information of a transaction and the authorization ID transmitted from a second terminal device, the authorization ID being acquired by the second terminal device from the first terminal device, the transaction information including at least ID of the second party and transaction value of the transaction.

The reduction module 603 is configured to reduce the transaction value from a first value included in the user account of the first party and add the transaction value to a second value included in the user account of the second party according to the stored corresponding relationship between the authorization ID and the account information, the authorization ID and the transaction information.

The acquisition module 601 may further include:

a reception unit configured to receive a user ID of a first party and an account ID of a user account thereof transmitted from the first terminal device;

a first acquisition unit configured to acquire the account information of the user account from the stored corresponding relationship among the account ID, the user ID and the account information according to the account ID and the user ID;

a generation unit configured to generate an authorization ID according to the account information of the user account and the current time, the authorization ID being configured to identify the account information of the user account;

a storage unit configured to store the authorization ID and the account information of the user account in the corresponding relationship between the authorization ID and the account information.

The reduction module 603 includes:

a second acquisition unit configured to acquire the account information of the user account from the stored corresponding relationship between the authorization ID and the account information according to the authorization ID, the account information including IDs of the user account and account management system of the first party;

a transmission unit configured to transmit the user account of the first party and the transaction information to the account management system according to the account management system ID, causing the account management system to reduce the transaction value from a first value included in the user account of the first party and to add the transaction value to a second value included in the user account of the second party according to the user account of the first party and the transaction information.

Further, the apparatus may include:

a registration module configured to receive a registration request message, the registration request message carrying the user ID of the first party and the account information of the user account thereof; to assign an account ID to the user account, and to create a corresponding relationship among the user ID, the account ID and the account information.

In this embodiment of the disclosure, the method includes: receive a user ID of a first party and an account ID of a user account thereof transmitted from the first terminal device, generate an authorization ID according to the account ID and the user ID and create a corresponding relationship between the authorization ID and the account information of the user account, and transmit the authorization ID to the first terminal device; receive transaction information of a transaction and the authorization ID transmitted from a second terminal device, the authorization ID being acquired by the second terminal device from the first terminal device; reduce the transaction value from a first value included in the user account of the first party and add the transaction value to a second value included in the user account of the second party according to the stored corresponding relationship between the authorization ID and the account information, the authorization ID and the transaction information. In the entire processing process, the account information of the user account of the first party may be always located in the payment system, making it impossible for others to steal the account information; the authorization ID is generated when processing of the transaction begins and is valid only during the current processing process, so even if it is acquired by others after processing of the transaction is completed, the personal information and account information of the first party cannot be enquired using the authorization ID, and the second terminal device acquires the authorization ID directly from the first terminal device, thereby ensuring that the authorization ID is not exposed directly and stolen by others and improving the security of personal information and account information.

It should be understood by those with ordinary skill in the art that all or some of the acts of the foregoing embodiments may be completed by hardware, and may also be completed by hardware instructed by program, the program being stored in a computer-readable storage medium, and the computer readable storage medium may be a read-only memory, a magnetic disk or a compact disk.

Disclosed above are only example embodiments of the present disclosure and these example embodiments are not intended to be limiting the scope of the present disclosure, hence any variations, modifications or replacements made without departing from the spirit of the present disclosure shall fall within the scope of the present disclosure.

What is claimed is:

1. A method for processing a transaction, comprising:
transmitting, by a first terminal device having a processor, a user identifier (ID) of a first party and an account ID of a first user account of the first party to a computer system;
generating, by the computer system, an authorization ID according to the account ID and the user ID, obtaining a corresponding relationship between the authorization ID and account information of the first user account, the account information comprising IDs of the first user account and account management system of the first party, and transmitting the authorization ID to the first terminal device;
acquiring, by a second terminal device, the authorization ID and transmits transaction information of the transaction and the authorization ID to the computer system, the transaction information comprising an ID of the second party and a transaction value of the transaction; and
reducing, by the computer system, the transaction value from a first value in the user account of the first party and adds the transaction value to a second value in a second user account of the second party according to the obtained corresponding relationship, the authorization ID, and the transaction information.

2. The method of claim 1, wherein the method further comprises the following acts after the computer system transmits the authorization ID to the first terminal device:
generating and displaying, by the first terminal device, a graphic code according to the authorization ID, the graphic code comprising the authorization ID; and
scanning, by the second terminal device, the graphic code displayed by the first terminal device and acquiring the authorization ID from the graphic code.

3. The method of claim 1, wherein the second terminal device real-timely transmits a radio frequency signal, the radio frequency signal having a pre-set transmission distance;
the method further comprising:
detecting, by the first terminal device, the radio frequency signal and transmits a responsive radio frequency signal to the second terminal device, wherein the distance between the second terminal device and the first terminal device is smaller than or equal to the pre-set transmission distance; and
receiving, by the second terminal device, the responsive radio frequency signal, establishes short-range wireless NFC connection with the first terminal device according to the responsive radio frequency signal, and acquiring the authorization ID from the first terminal device through the NFC connection.

4. The method of claim 1, wherein the method further comprises the following acts before the first terminal device transmits a user ID of a first party and an account ID of a user account thereof to a computer system:
transmitting, by the first terminal device, a registration request message to the computer system, the registration request message carrying the user ID of the first party and the account information of the user account thereof; and
assigning, the computer system, an account ID to the user account, and creating the corresponding relationship among the user ID, the account ID and the account information.

5. A method for processing transactions, comprising:
receiving, by a computer system, a user ID of a first party and an account ID of a user account of the first party transmitted from the first terminal device, generating an authorization ID according to the account ID and the user ID and create a corresponding relationship between the authorization ID and the account information of the user account, the account information comprising IDs of the user account and account management system of the first party, and transmit the authorization ID to the first terminal device;
receiving, by the computer system, transaction information of a transaction and the authorization ID transmitted from a second terminal device, the authorization ID being acquired by the second terminal device from the first terminal device, the transaction information including at least ID of the second party and transaction value of the transaction; and
reducing, by the computer system, the transaction value from a first value included in the user account of the first party and add the transaction value to a second value included in the user account of the second party according to the corresponding relationship between the authorization ID and the account information, the authorization ID and the transaction information.

6. The method of claim 5, wherein generating an authorization ID according to the account ID and the user ID and create the corresponding relationship between the authorization ID and the account information of the user account comprises:
acquiring the account information of the user account from the stored corresponding relationship among the account ID, the user ID and the account information according to the account ID and the user ID;
generating an authorization ID according to the account information of the user account and the current time, the authorization ID being configured to identify the account information of the user account; and
storing the authorization ID and the account information of the user account in the corresponding relationship between the authorization ID and the account information.

7. The method of claim 5, wherein reducing the transaction value from a first value included in the user account of the first party and add the transaction value to a second value included in the user account of the second party according to the corresponding relationship between the authorization ID and the account information, the authorization ID and the transaction information comprises:
acquiring the account information of the user account from the stored corresponding relationship between the authorization ID and the account information according to the authorization ID, the account information including IDs of the user account and account management system of the first party; and
transmitting the user account of the first party and the transaction information to the account management system according to the account management system ID so that the account management system reduces the transaction value from a first value included in the user account of the first party and adds the transaction value to a second value included in the user account of the second party according to the user account of the first party and the transaction information.

8. The method of claim 5, wherein the method further comprises the following acts before receiving the user ID of the first party and the account ID of the user account transmitted from the first terminal device:
receiving a registration request message, the registration request message carrying the user ID of the first party and the account information of the user account thereof; and
assigning an account ID to the user account, and create the corresponding relationship among the user ID, the account ID, and the account information.

9. A system for processing transactions, comprising: a first terminal device, a second terminal device, and a computer system; wherein:
the first terminal device is configured to transmit a user ID of a first party and an account ID of a user account thereof to the computer system;
the computer system is configured to generate an authorization ID according to the account ID and the user ID and to create a corresponding relationship between the authorization ID and the account information of the user account, the account information including IDs of the user account and account management system of the first party, and to transmit the authorization ID to the first terminal device;
the second terminal device is configured to acquire the authorization ID from the first terminal device and to transmit transaction information of a transaction and the authorization ID to the computer system, the transaction information including at least ID of the second party and transaction value of the transaction; and
the computer system is further configured to reduce the transaction value from a first value included in the user account of the first party and to add the transaction value to a second value included in the user account of the second party according to the corresponding relationship between the authorization ID and the account information, the authorization ID and the transaction information.

10. The system of claim 9, wherein:
the first terminal device is further configured to generate and display a graphic code according to the authorization ID, the graphic code including the authorization ID; and
the second terminal device is configured to scan the graphic code displayed by the first terminal device and to acquire the authorization ID from the graphic code.

11. The system of claim 9, wherein:
the second terminal device is also configured to real-timely transmit a radio frequency signal, of the radio frequency signal having a pre-set transmission distance;
the first terminal device is configured to detect the radio frequency signal and to transmit a responsive radio frequency signal to the second terminal device, wherein the distance between the second terminal device and the first terminal device is smaller than or equal to the pre-set transmission distance; and
the second terminal device is also configured to receive the responsive radio frequency signal, to establish short-range wireless NFC connection with the first terminal device according to the responsive radio frequency signal, and to acquire the authorization ID from the first terminal device through the NFC connection.

12. The system of claim 9, wherein:
the first terminal device is further configured to transmit a registration request message to the computer system, the registration request message carrying the user ID of the first party and the account information of the user account thereof; and
the computer system is further configured to assign an account ID to the user account, and to create the corresponding relationship among the user ID, the account ID, and the account information.

13. An apparatus for processing transactions, comprising a hardware processor and a non-transitory storage medium accessible to the processor, the non-transitory storage medium is configured to store the following modules implemented by the hardware processor:
an acquisition module configured to receive a user ID of a first party and an account ID of a user account thereof transmitted from the first terminal device, to generate an authorization ID according to the account ID and the user ID and to create a corresponding relationship between the authorization ID and the account information of the user account, the account information including IDs of the user account and account management system of the first party, and to transmit the authorization ID to the first terminal device;
a reception module configured to receive transaction information of a transaction and the authorization ID transmitted from a second terminal device, the authorization ID being acquired by the second terminal device from the first terminal device, the transaction information including at least ID of the second party and transaction value of the transaction; and
a reduction module configured to reduce the transaction value from a first value included in the user account of the first party and add the transaction value to a second value included in the user account of the second party according to the stored corresponding relationship between the authorization ID and the account information, the authorization ID and the transaction information.

14. The apparatus of claim 13, wherein the acquisition module comprises:
a reception unit configured to receive a user ID of a first party and an account ID of a user account thereof transmitted from the first terminal device;
a first acquisition unit configured to acquire the account information of the user account from the stored corresponding relationship among the account ID, the user ID and the account information according to the account ID and the user ID;
a generation unit configured to generate an authorization ID according to the account information of the user account and the current time, the authorization ID being configured to identify the account information of the user account; and
a storage unit configured to store the authorization ID and the account information of the user account in the corresponding relationship between the authorization ID and the account information.

15. The apparatus of claim 13, wherein the reduction module comprises:
a second acquisition module configured to acquire the account information of the user account from the stored corresponding relationship between the authorization ID and the account information according to the authorization ID, the account information including IDs of the user account and account management system of the first party; and
a transmission unit configured to transmit the user account of the first party and the transaction information to the account management system according to the account management system ID so that the account management system reduces the transaction value from a first value included in the user account of the first party and adds the transaction value to a second value included in the user account of the second party according to the user account of the first party and the transaction information.

16. The apparatus of claim 13, further comprising:
a registration module configured to receive a registration request message, the registration request message carrying the user ID of the first party and the account information of the user account thereof; to assign an account ID to the user account, and to create the corresponding relationship among the user ID, the account ID, and the account information.
